(19) United States
(12) Patent Application Publication
(10) Pub. No.: US 2012/0216110 A1
(43) Pub. Date: Aug. 23, 2012

(54) INFORMATION PROCESSING DEVICE

(75) Inventors: Shinichi Kariya, Tokyo (JP); Hirotoshi Maegawa, Tokyo (JP)

(73) Assignee: SONY COMPUTER ENTERTAINMENT INC., Tokyo (JP)

(21) Appl. No.: 13/503,519

(22) PCT Filed: May 14, 2010
(86) PCT No.: PCT/JP2010/003287

§ 371 Date: Apr. 23, 2012

(30) Foreign Application Priority Data
Oct. 26, 2009 (JP) 2009-245643

(51) Int. Cl. G06F 17/00

(52) U.S. Cl. 715/234

(57) ABSTRACT

A data acquiring unit acquires provided data from an information providing server. A format retaining unit retains configuration format data of a page. The page reconfiguration unit generates page data wherein the acquired provided data is arranged in accordance with configuration format data. The hierarchical data generating unit generates a page image from the generated page data, and generates hierarchical data where page images of a plurality of resolutions are hierarchized by using the generated page image.

### TECHNICAL FIELD

The present invention relates to an information processing technology for acquiring provided data, such as web data or the like, from an information providing server and for generating a page image to be displayed on a display of a terminal device.

### BACKGROUND ART

Home entertainment systems capable of playing back moving images as well as running game programs have been proposed. In the home entertainment systems, a GPU generates three-dimensional images using polygons (see, for example, patent document No. 1).

Technology capable of the enlargement or reduction of a displayed image or the movement of the image in the upward, downward, leftward, or rightward directions, is proposed, by using tile images of a plurality of resolutions generated from a digital image such as a high-definition photo or the like. In this image processing technology, the size of an original image is reduced in a plurality of stages to generate images of different resolutions so as to represent the original image in a hierarchical structure, where the image in each layer is divided into one or more tile images. Normally, the image with the lowest resolution is composed of one tile image. The original image with the highest resolution is composed of the largest number of tile images. An image processing device is configured, when enlarging or reducing a displayed image, to switch from a currently-used tile image to a tile image from a different layer so as to enlarge or reduce the displayed image efficiently.

### RELATED ART LIST

### Patent Documents

[PATENT DOCUMENTS1] U.S. Pat. No. 6,563,999

### SUMMARY OF THE INVENTION

### Problem to be Solved by the Invention

The layouts of web pages provided by a web server are designed based on the premise that a web page is controlled so as to be scrolled in the vertical direction on a display, since the web pages are displayed on displays of personal computers, mobile terminal devices, or the like. On a website, hyperlinks are set between web pages and pages are switched by jumping to a link destination.

A scheme is put into a web site so as to display on the top page a menu of the entire site in order to show users the configuration of the site. However, this has not yet led to provide a complete picture of the site to users. In addition, although new information is provided to users by allowing a page to jump to a link destination by a hyperlink, the continuity of information is broken since pages are completely switched. Therefore, users actually have difficulties in grasping a relationship between a page before switching and a page after switching. Thus, it is desired to provide users with pages with which a complete picture of the site and/or the relationship between pieces of information can be grasped easily.

Further, it is desired to provide users not only with data provided by a web server but also with data provided by other servers that provide information, by using pages with which the relationship between pieces of information can be grasped easily. In addition, it is also desired to provide users with web search results or the like in an easy-to-view manner.

The present invention addresses the aforementioned issue, and a purpose thereof is to provide a technology for effectively presenting to users data provided by an information providing server.

### Means to Solve the Problem

In order to address the aforementioned issue, an information processing device connected with an information providing server is provided according to an aspect of the present invention. The information processing device includes: a data acquiring unit operative to acquire provided data from the information providing server; a format retaining unit operative to retain configuration format data of a page; a reconfiguration unit operative to generate page data wherein the provided data acquired by the data acquiring unit is arranged in accordance with the configuration format data retained in the format retaining unit; and a hierarchical data generating unit operative to generate one or more page images from the generated page data, and to generate hierarchical data wherein page images of a plurality of resolutions are hierarchized by using the one or more page images generated.

Optional combinations of the aforementioned constituting elements, and implementations of the invention in the form of methods, apparatuses, systems, computer programs, and recording media that store computer programs may also be practiced as additional modes of the present invention.

### BRIEF DESCRIPTION OF THE DRAWINGS

FIG. 1 shows an information processing system according to an exemplary embodiment of the present invention;

FIG. 2 shows an outward structural appearance of an input device;

FIG. 3 shows a hierarchical structure of image data used in the information processing system;

FIG. 4 shows the configuration of an information processing device;

FIG. 5 shows the configuration of a control unit that generates hierarchical data;

FIG. 6 shows an exemplary conventional screen image when displaying a top page of a news site with a web browser;

FIGS. 7A-C show examples of page configuration information;

FIG. 8 shows an example of a top page image;

FIG. 9 shows an example of a summary page image;

FIG. 10 shows an example of a detail page image;

FIG. 11 shows the connection relationship among pages in three tiers in a hierarchical data structure;

FIG. 12 shows an example of connection among hierarchical data sets according to the exemplary embodiment;

FIG. 13 schematically shows a relationship between sets of hierarchical data;

FIG. 14 shows the configuration of a control unit that changes a displayed image;

FIG. 15 shows a flowchart of a generation process of hierarchical data; and

FIG. 16 shows an example of a top page image that displays a search result.

### MODE FOR CARRYING OUT THE INVENTION

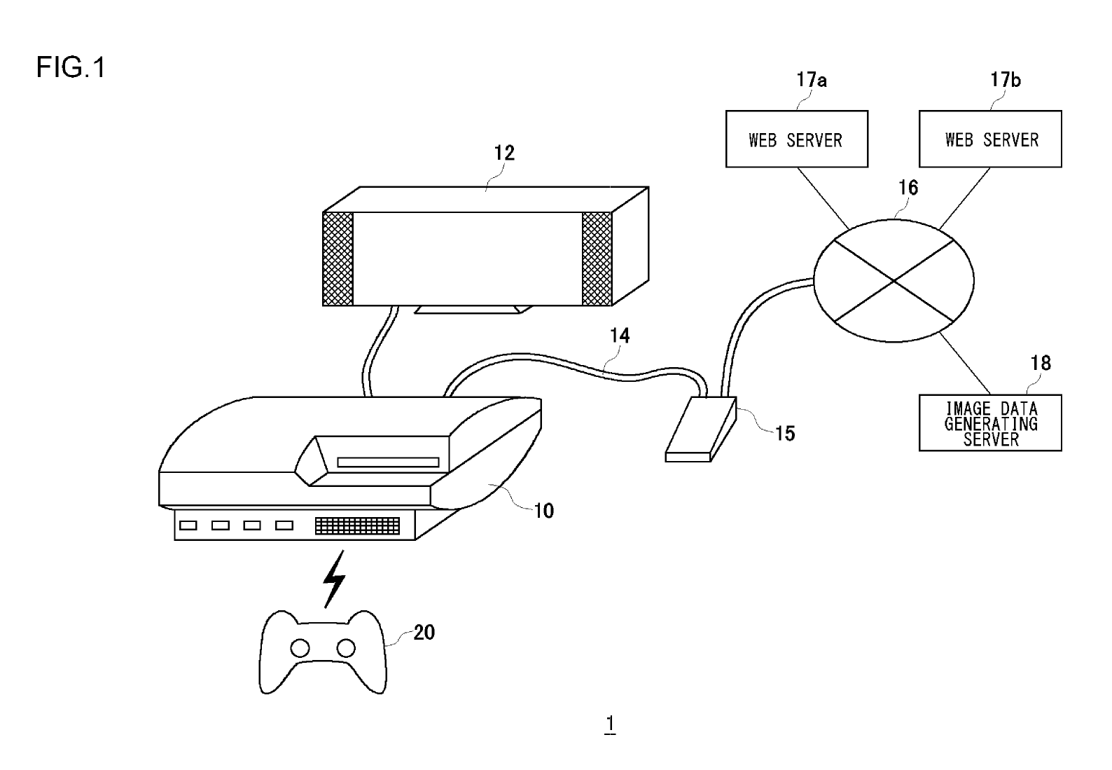

FIG. 1 shows an information processing system 1 according to an exemplary embodiment of the present invention. The information processing system 1 comprises an input device 20, an information processing device 10 configured to execute an image processing software, and a display device 12 configured to output a result of processing by the information processing device 10. The display device 12 may be a television set provided with a display for outputting an image and a speaker for outputting sound. The display device 12 may be a computer display. The display device 12 may be connected to the information processing device 10 by cable or connected wirelessly using, for example, wireless Local Area Network (LAN), or the like. The information processing device 10, the input device 20, and the display device 12 may be formed integrally. For example, the devices may be configured as a mobile terminal device provided with image processing function.

In the information processing system 1, the information processing device 10 is connected with a router 15 by a cable 14. The router 15 is connected with an external network 16, such as the Internet or the like. Connected with the network 16 are web servers 17a, 17b (hereinafter referred to as a “web server 17” when referred collectively) and an image data generating server 18. Thereby, the information processing device 10 is connected with the web servers 17 and the image data generating server 18 via the network 16. The web server 17 represents an example of an information providing server connected with the world wide web (WWW). The information providing server may be connected with the information processing device 10 via an intranet, or may be directly connected with the information processing device 10 without passing through any networks.

The information processing device 10 may be, for example, a game device, and the image processing function thereof may be implemented by loading an application program for image processing. The information processing device 10 may be a personal computer, and the image processing function thereof may be implemented by loading an application program for image processing.

The information processing device 10 collects data provided by information providing servers (hereinafter referred to as “provided data”). The information processing device 10 may collect provided data from a single information providing server, or may collect provided data from a plurality of information providing servers. In an exemplary embodiment below, explanations will be given while assuming that the information providing server is the web server 17 that is connected with the Internet.

The information processing device 10 collects web data from the web server 17. The information processing device 10 may collect web data from a web site provided by a single web server 17, or may collect web data from a plurality of web sites. The information processing device 10 generates a page image to be displayed on the display device 12 by using collected web data. The information processing device 10 reduces the size of the generated page image into a plurality of stages to generate page images of different resolutions so as to generate hierarchical data where page images of a plurality of resolutions are hierarchized.

The information processing device 10 uses the generated hierarchical data so as to display an image on a display of the display device 12. A user operates the input device 20 while watching the image displayed on the display, and the input device 20 transmits an instruction signal for changing the displayed image to the information processing device 10. The information processing device 10 executes, in accordance with a user request which is input by a user to the input device 20, a process of changing an image to be displayed on the display of the display device 12. For example, the information processing device 10 enlarges/reduces the image or moves the image upward, downward, leftward, or rightward.

In the information processing system 1, the image data generating server 18 may function as an information processing device that collects provided data from an information providing server, such as the web server 17 or the like, and that generates hierarchical data. In this process, the information processing device 10 may acquire the hierarchical data generated in the image data generating server 18 via the network 16, may display an image on the display of the display device 12, and may enlarge or reduce the image and/or move the image in the upward, downward, leftward, or rightward directions in accordance with a change instruction signal. In this process, the information processing device 10 may acquire all of the hierarchical data from the image data generating server 18, or may acquire only a portion of the hierarchical data required for generating an image to be displayed.

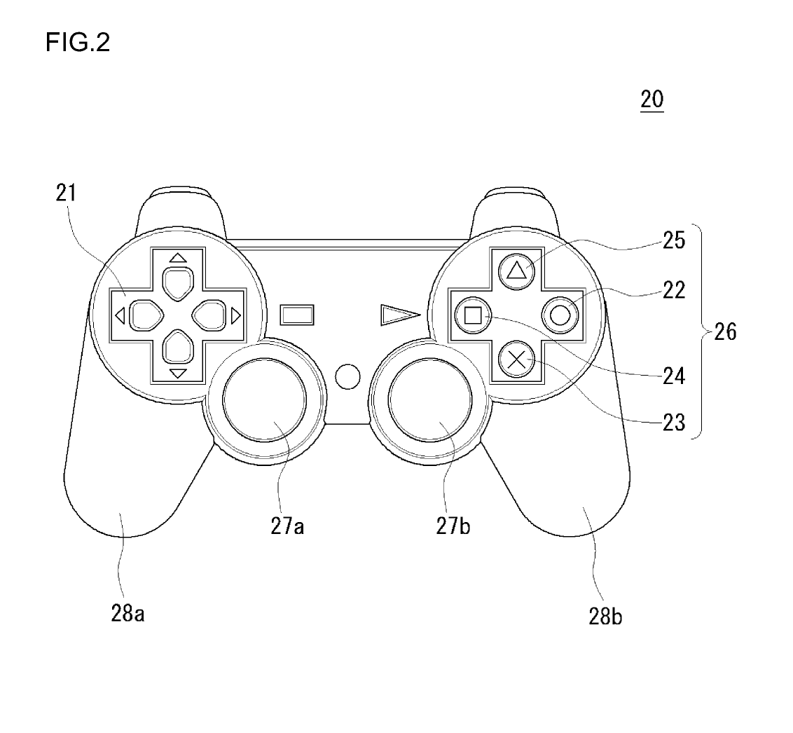

FIG. 2 shows an outward structural appearance of the input device 20. The input device 20 comprises directional keys 21, analog sticks 27a and 27b, and four types of control buttons 26, as means of operation that can be manipulated by a user. The four types of control buttons 26 includes a circle button 22, a cross button 23, a square button 24, and a triangle button 25.

After the information processing device 10 of the information processing system 1 generates hierarchical data by itself, or after the device 10 acquires hierarchical data from the image data generating server 18, the user control means of the input device 20 is assigned the function of entering an instruction to enlarge/reduce an displayed image, and an instruction to scroll upward, downward, leftward, or rightward (herein after referred to as a “image change instruction signal,” collectively). For example, the function of entering an instruction to enlarge/reduce a displayed image is assigned to the right analog stick 27b. The user can enter an instruction to reduce the size of a displayed image by pulling the analog stick 27b toward the user and can enter an instruction to enlarge a displayed image by pushing it away from the user. The function of entering an instruction for scrolling a displayed image is assigned to the left analog stick 27a. By tilting the analog stick 27a upward, downward, leftward, or rightward, the user can enter an instruction for scrolling in the direction in which the analog stick 27a is tilted. In this manner, the analogue sticks 27a and 27b are used for scrolling a displayed image continuously, and for enlarging/reducing the image continuously.

The input device 20 has the function of transferring an input image change instruction signal to the information processing device 10. In the exemplary embodiment, the input device 20 is configured to be capable of communicating wirelessly with the information processing device 10. The input device 20 and the information processing device 10 may establish wireless communication using the Bluetooth (registered trademark) protocol or the IEEE802.11 protocol or the like. The input device 20 may be connected to the information processing device 10 via a cable so as to transfer an image change instruction signal to the information processing device 10.

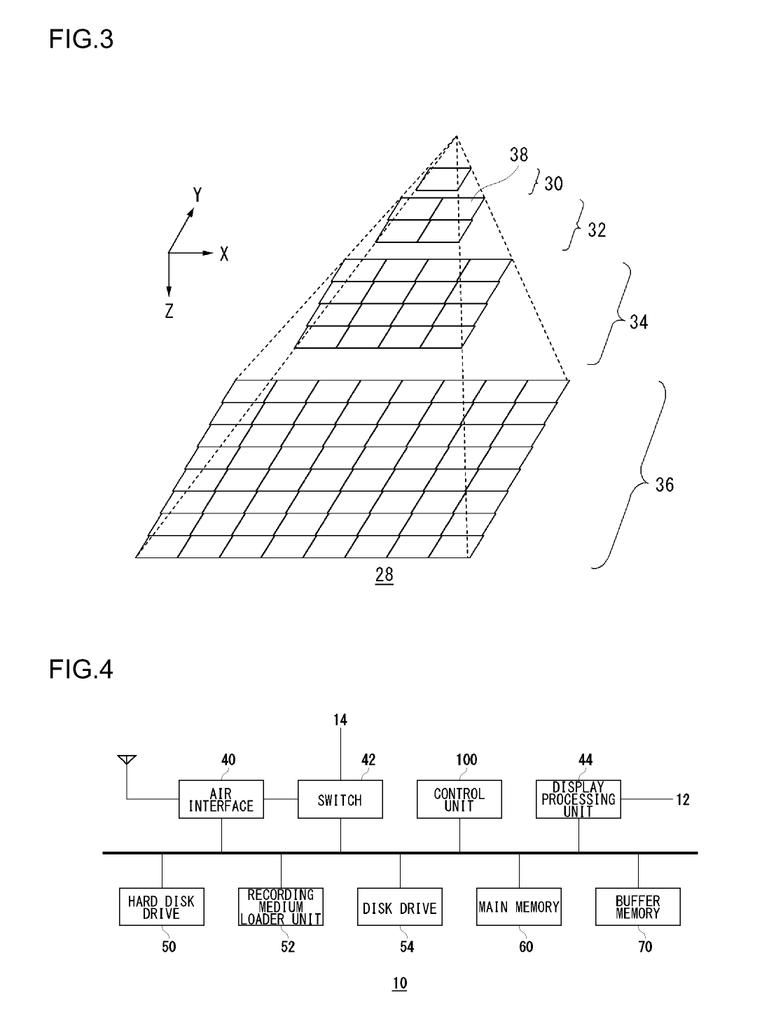

FIG. 3 shows the hierarchical structure of image data used in the information processing system 1. The information processing device 10 uses the image data to generate an image to be displayed. The image data has a hierarchical structure comprising a 0-th layer 30, a first layer 32, a second layer 34, and a third layer 36 in the direction of depth (Z axis). Hereinafter, image data having such a hierarchical structure will be referred to as “hierarchical data”. A layer higher than the fourth layer may be provided. The hierarchical data 28 shown in FIG. 3 has a quadtree hierarchical structure. Each layer comprises one or more tile images 38. All of the tile images 38 are formed to have the same size having the same number of pixels. For example, the images have 256 by 256 pixels, respectively. The image data in the respective layers are representations of a single image in different resolutions. The original image in the third layer 36 having the highest resolution is reduced in a plurality of stages to generate the image data for the second layer 34, the first layer 32, and the 0-th layer 30. For example, the resolution of the Nth layer (N is an integer equal to or greater than 0) may be ½ the resolution of the (N+1)th layer in both the horizontal (X axis) direction and the vertical (Y axis) direction.

In the hierarchical data shown in FIG. 3, the position in the depth (Z axis) direction indicates the resolution. The closer to the 0-th layer 30, the lower the resolution, and, the closer to the third layer 36, the higher the resolution. In terms of the size of the image displayed on the display, a position in the depth direction represents a scaling factor. Assuming that the scaling factor of a displayed image of the third layer 36 is 1, the scaling factor of the second layer 34 is ¼, the scaling factor of the first layer 32 is 1/16, and the scaling factor of the 0-th layer 30 is 1/64. Therefore, if a displayed image changes in the depth direction away from the 0-th layer 30 toward the third layer 36, the displayed image is enlarged. If a displayed image changes in the direction away from the third layer 36 toward the 0-th layer 30, the displayed image is reduced.

In the information processing device 10, the hierarchical data 28 is stored in a storage device in a predefined compressed format. The compressed hierarchical data 28 is read from the storage device and decoded before being displayed on the display. Compression of the hierarchical data may be performed for each tile image. Alternatively, a plurality of tile images included in the same layer or included in a plurality of layers may be compressed at a time.

As shown in FIG. 3, the hierarchical structure of the hierarchical data 28 is configured such that the horizontal direction is defined as the X axis, the vertical direction is defined as the Y axis, and the depth direction is defined as the Z axis, thereby building a virtual three-dimensional space. In this hierarchical structure, the X axis and the Y axis define a common coordinate system having the same origin point. Upon deriving the amount of change of a displayed image by referring to an image change instruction signal supplied from the input device 20, the information processing device 10 uses the amount of change to derive information specifying a layer and texture coordinates (UV coordinates) in the layer. The combination of the information specifying a layer and the texture coordinates will be referred to as spatial coordinates. Spatial coordinates in a virtual space are used to generate an image to be displayed. The information processing device 10 may derive the coordinates of the four corners of a frame image in the virtual space by using the amount of change of a displayed image. The frame coordinates of the four corners will also be referred to as spatial coordinates. The information processing device 10 may drive the coordinates (X, Y) of the center of the frame image in the virtual space and the scaling factor SCALE.

For example, in case of viewing an image change instruction signal from a user as a request to move a virtual camera in the hierarchical structure of hierarchical data 28, the combination of the coordinates of the center of the frame image and information on the scaling factor (X, Y, SCALE) may be referred to as virtual camera image coordinates. Hereinafter, for the convenience of explanation, (X, Y SCALE) are referred to as virtual camera image coordinates, and the image change instruction signal is represented as a signal for moving the virtual camera in the virtual space and for specifying the virtual camera image coordinates (X, Y, SCALE) for each frame. The scaling factor SCALE may be defined as the scaling factor of a frame image when assuming that the scaling factor of the displayed image of the third layer 36 is 1.

FIG. 4 shows the structure of the information processing device 10. The information processing device 10 comprises an air interface 40, a switch 42, a display processing unit 44, a hard disk drive 50, a recording medium loader unit 52, a disk drive 54, a main memory 60, a buffer memory 70, and a control unit 100. The display processing unit 44 is provided with a frame memory for buffering data to be displayed on the display of the display device 12.

The switch 42 is an Ethernet switch (Ethernet is a registered trademark), a device connected to an external device via a cable or wirelessly so as to transmit and receive data. The switch 42 is connected to the network 16 via the cable 14 so as to receive from the web server 17 web data for generating hierarchical data. In case that the image data generating server 18 generates the hierarchical data, the switch 42 receives the hierarchical data from the image data generating server 18.

The switch 42 is connected to the air interface 40. The air interface 40 is connected to the input device 20 using a predefined wireless communication protocol. An image change instruction signal, which is input by a user through the input device 20, is supplied to the control unit 100 via the air interface 40 and the switch 42.

The hard disk drive 50 functions as a storage device for storing data. The data received via the switch 42 is stored in the hard disk drive 50. If a removable recording medium such as a memory card or the like is mounted, the recording medium loader unit 52 reads data from the removable recording medium. If a read only memory (ROM) disk is mounted, the disk drive 54 drives and recognizes the ROM disk so as to read out data. The ROM disk may be an optical disk, a magneto-optical disk, or the like.

The control unit 100 is provided with a multi-core CPU. One general-purpose processor core and a plurality of simple processor cores are provided in a single CPU. The general-purpose processor core is referred to as a Power

Processing Unit (PPU) and the other processor cores are referred to as Synergistic Processing Units (SPUs).

The control unit 100 is provided with a memory controller connected to the main memory 60 and to the buffer memory 70. The PPU is provided with a register and a main processor as an entity that executes a computation. The PPU efficiently allocates tasks as basic units of processing in applications to be executed to the respective SPUs. The PPU itself may execute a task. The SPU is provided with a register, a sub-processor as an entity that executes a computation, and a local memory as a local storage area. The local memory may be used as the buffer memory 70.

The main memory 60 and the buffer memory 70 are storage devices and are formed as random access memories (RAMs). The SPU is provided with a dedicated direct memory access (DMA) controller as a control unit and is capable of high-speed data transfer between the main memory 60 and the buffer memory 70. High-speed data transfer is also achieved between the frame memory in the display processing unit 44 and the buffer memory 70. The control unit 100 according to the exemplary embodiment implements high-speed image processing function by operating a plurality of SPUs in parallel. The display processing unit 44 is connected to the display device 12 and outputs an image processing result in accordance with a request from a user.

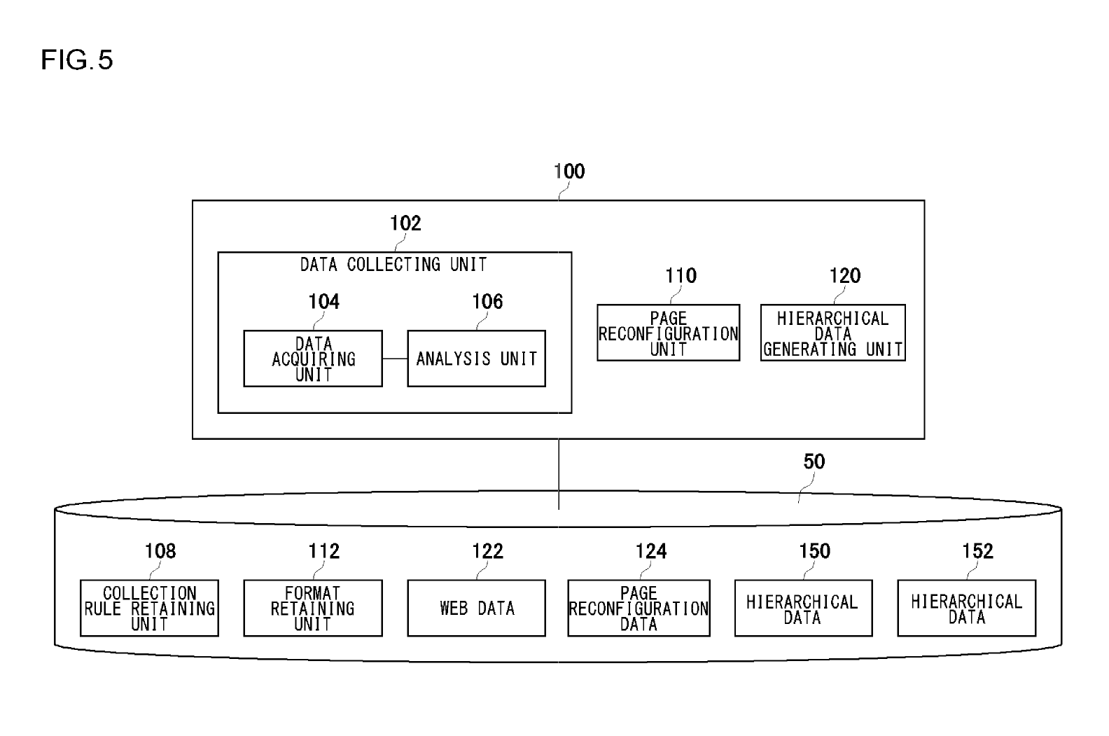

FIG. 5 shows the configuration of a control unit 100 that generates hierarchical data. The control unit 100 comprises a data collecting unit 102, a page reconfiguration unit 110, and a hierarchical data generating unit 120. The data collecting unit 102 is provided with a data acquiring unit 104 and an analysis unit 106. The hard disk drive 50 is provided with a collection rule retaining unit 108 and a format retaining unit 112. The collection rule retaining unit 108 retains a collection rule for collecting web data by the data collecting unit 102. The format retaining unit 112 retains configuration format data of a page to be reconfigured by the page reconfiguration unit 110.

The data collecting unit 102 collects web data from one or more web servers 17 in accordance with the collection rule retained in the collection rule retaining unit 108. Examples of the collection rule are as follows.

### (Collection Rule 1)

Data of a web page that constitutes a web site is collected. A web page is a set of assembled data that is described in markup language and is displayed at a time by a web browser. For example, a web page comprises layout information in Hyper Text Markup Language (HTML), text data, and link information of an image, sound, a moving image, or the like that are embedded in the page. A web site is a group of assembled web pages, and comprises a top page (home page) and other pages that are linked from the top page. The data of a web page represents data included in the web page, such as tag information, text information, image information, link information, or the like.

The collection rule 1 is used in case of collecting web data of a web site and reconfiguring pages. For example, the collection rule 1 is applied in case of collecting news items from a news site, rearranging the categories of news content or news headlines in a layout that is different from an original web page, and reconfiguring a page image indicating a complete picture of the news site and a page image for each category. The collection rule 1 is defined for each website to be reconfigured. The collection rule 1 may be defined so as to acquire all of the web pages constituting the web site, or may be defined so as to acquire a part of the web pages.

(Collection Rule 2)

Data of web content that is a result of web search is collected. The collection rule 2 is used in case of collecting web data that represents web search results and configuring a page for listing the search results with increased viewer-friendliness. For example, the collection rule 2 is applied to a case of collecting data of commercial products (contents) that are narrowed down by a user using a search key at an e-commerce site, and of configuring a page for a listing wherein respective commercial products that are acquired as the search result are arranged so that the user can readily view and compare the commercial products. In this process, if image data of the narrowed-down contents exist, the image data is also collected, whereby the value of the page for a listing can be increased.

The collection rule is retained in the collection rule retaining unit 108 and, upon being selected by a user, is read out to the data acquiring unit 104. Hereinafter, an explanation will be given on an exemplary case where the data acquiring unit 104 acquires web data in accordance with the collection rule 1. In case that the collection rules are defined for respective websites, if the top page of a website is specified by a user, a collection rule defined for the web site may be read out from the collection rule retaining unit 108.

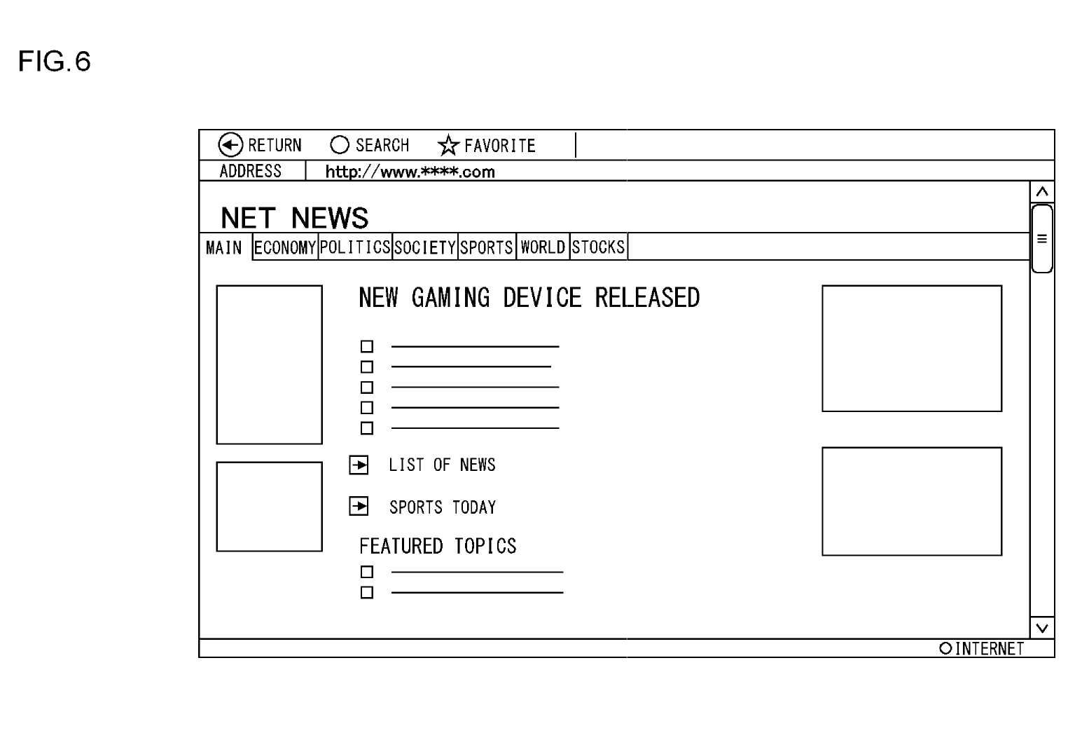

FIG. 6 shows an exemplary conventional screen image when a top page of a news site is displayed by a web browser. Provided on the top page of the web site are tabs for selecting a news category as shown in FIG. 6, that is, “main,” “economy,” “politics,” “society,” “sports,” “world,” and “stocks”. On the top page, the “main” tab is selected as a default and the headlines of news items categorized as the “main” are displayed. The top page adopts a scheme where a user can access, by selecting a tab, a web page that displays news headlines of the selected news category. However, the user cannot tell from the top page what kind of news items exist in each category unless the user selects a tab. Therefore, it is hardly said that the conventional top image shown in FIG. 6 has a high viewer-friendliness for a listing of news items.

For that reason, the information processing device 10 according to the exemplary embodiment reconfigures, in order to increase the viewer-friendliness of pages, the top page of a web site and news item pages for respective categories to be transitioned from the top page, on the basis of the collected web data.

The data acquiring unit 104 acquires a web page from the web server 17. First, the data acquiring unit 104 acquires a top page, and the analysis unit 106 analyzes a text file of the top page, accordingly. The analysis unit 106 is configured, for example, as a HyperText Markup Language (HTML) parser, or as an extensible Markup Language (XML) parser, and extracts link information, an image file name, path information, or the like included in the text file of a top page acquired by the data acquiring unit 104. The analysis unit 106 returns the extracted link information, the image file name, and the path information to the data acquiring unit 104. The data acquiring unit 104 acquires from the link information a web page to which a link is provided, and further acquires image data by referring to the image file name and the path information. The data acquiring unit 104 and the analysis unit 106 repeat this process and ultimately collect the data of all web pages that compose the web site. The collected web data 122 is stored in the hard disk drive 50.

The page reconfiguration unit 110 generates page data wherein the collected web data 122 is rearranged in accordance with the configuration format data retained in the format retaining unit 112. Although the web server 17 provides web data in the format of a web page, the page reconfiguration unit 110 generates page data wherein the web data 122 is rearranged in a manner different from that of the web page in accordance with the configuration format data. Since the generated page data is thereafter converted into image data by the hierarchical data generating unit 120, any data format can be adopted for the page data. However, the page data may be generated in the same language as the website in order to facilitate the process. The configuration format data defines the format of a page to be reconfigured, the type of web data to be included in the page, or the like. The configuration format data is defined for each web site.

In the exemplary embodiment, the configuration format data includes page configuration information required in order to rearrange web data of a news site in three tiers of pages and to configure pages of respective tiers. More specifically, the configuration format data includes page configuration information for generating: a top page for overviewing the entire site; a page for displaying a summary with an emphasis; and a page for displaying news items in detail. The top page has a role as a page for a listing to display as a list the contents of the website as a whole. The page for displaying a summary with an emphasis and the page for displaying news items in detail have a role as a page for individual information to display individual information in the website. Hereinafter, the page for displaying a summary with an emphasis is referred to as a “summary page,” and the page for displaying news items in detail is referred to as a “detail page,” respectively. In the summary page and in the detail page, news contents are laid out substantially in the same manner. In the summary page, the titles of news items are displayed with an emphasis in comparison with the detail page.

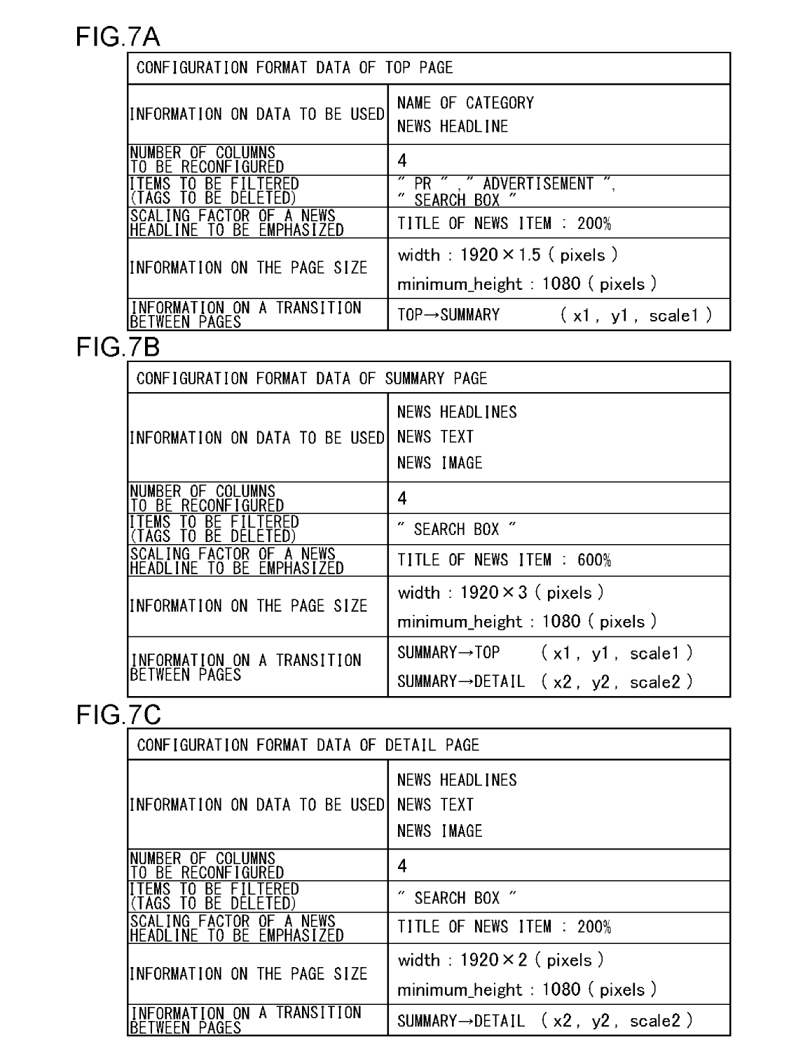

FIGS. 7A-C show examples of the configuration format data. Although the configuration format data is displayed in a table format in FIGS. 7A-C in order to facilitate the understanding thereof, any data format can be adopted for the configuration format data. FIG. 7A shows the page configuration information of a top page, FIG. 7B shows the page configuration information of a summary page, and FIG. 7C shows the page configuration information of a detail page. The page configuration information includes information on data to be used, the number of columns to be reconfigured, items to be filtered, a scaling factor of news headlines to be emphasized, information on the page size, and information on a transition between pages. Among the above information, the information on data to be used, the number of columns to be reconfigured, the items to be filtered, and the scaling factor of news headlines to be emphasized are used when page data is generated by the page reconfiguration unit 110. The information on the page size and the information on a transition between pages are used when the hierarchical data generating unit 120 converts the page data into image data so as to generate hierarchical data.

The information on data to be used specifies data to be used in order to configure a page. The information on data to be used for the top page includes the names of categories, and news headlines included in respective categories. The information on data to be used for the summary page and for the detail page include news headlines, news text, and a news image, respectively. The number of columns to be reconfigured defines the number of columns for arranging news contents in the horizontal direction of a page. In FIGS. 7A-C, the numbers of columns are defined as 4 for all pages. Therefore, on the top page, the names of categories and news headlines are reconfigured into four columns in the page. On the summary page and on the detail page, news headlines, news text, or the like are reconfigured into four columns in the pages, respectively.

The items to be filtered define information on a tag among tags included in the web page, the tag is not to be used in the configuration of the page. By providing the items to be filtered, data of the information on data to be used can be readily specified, and at the same time, data can be explicitly specified as data to be excluded from a page to be reconfigured. The items to be filtered is particularly useful in case of excluding specific data among data included in the information on data to be used. FIG. 7A shows an example where tag information of the “PR,” the “advertisement,” and the “search box” are defined as the items to be filtered from the top page. This excludes data related to the tags “PR,” “advertisement,” and “search box” from the top page. Since an image on the top page is displayed as an image for a listing to be viewed from a distance, an advertisement is not easily seen in the first place. Therefore, the top page is configured to include only information relating to the names of categories and news headlines. The tag information of the “search box” is defined as the item to be filtered out from the summery page and from the detail page. Since a search box is unnecessary for pages to be reconfigured, the tag information of the “search box” is defined as the item to be filtered out from all the pages. The scaling factor of news headlines to be emphasized indicates a magnification ratio of a news headline to be displayed with an emphasis in a page to be reconfigured.

The page reconfiguration unit 110 refers to the tag information of the web data 122 and extracts data required to configure respective pages in accordance with the information on data to be used included in the configuration format data. In this process, data associated with a tag specified by the items to be filtered is not used. The page reconfiguration unit 110 defines the number of columns for respective pages as 4 in accordance with the number of columns to be reconfigured, and rearranges the data extracted in accordance with the information on data to be used. When rearranging on a page, the font size included in the web data 122 is automatically used as the size of characters. However, the character size for the news headlines is changed in accordance with the scaling factor of news headlines to be emphasized, the factor included in the configuration format data. According to the configuration format data shown in FIGS. 7A-C, the character size of respective news titles are enlarged in comparison with the character size of the web data 122. This enables the page reconfiguration unit 110 to generate a page where news titles are enlarged. Therefore, the viewer-friendliness upon providing a list of news items is increased.

Although not shown in the figures, the configuration format data may include information for limiting the number of news headlines to be displayed on a top page, or the like. The information for limiting the number is defined as appropriate for respective categories. In case of limiting the number of news headlines to be displayed, news headlines may be determined as the news headlines to be displayed on the top page, for example in the order starting from the one with the newest creation time. The arrangement order of news headlines of respective categories in four columns may be determined in advance. Alternatively, the arrangement order may be determined in accordance with the number of news headlines so that respective columns have a same length in the vertical direction.

The hierarchical data generating unit 120 converts each page generated by the page reconfiguration unit 110 into image data (a page image). Any data format can be adopted for the image data. In page configuration data, the information on the page size defines the size of a page image to be generated. The information on the page size defines the breadth (width) and the minimum length (minimum_height) that specify a rendering area, and the hierarchical data generating unit 120 converts page data into an image in conformity with the breadth.

In the example shown in FIG. 7, the breadth is defined as a fixed value. For example, in case that the amount of data to be used for generating a page is predictable, the breadth may be defined as a fixed value. On the other hand, in case that the amount of data to be used for generating a page is unforeseeable until the data acquiring unit 104 acquires the data, it is preferable that the breadth is defined dynamically in accordance with the amount of data to be used. The breadth may be defined not only in accordance with the amount of data to be used but also in accordance with the characteristic of a web site, or the like.

It is preferable that the page reconfiguration unit 110 reconfigures a page on the basis of the page size information so that the entire page fits into an image frame having a predetermined aspect ratio (e.g., breadth:length is 16:9). Whereby, the entire page image can be displayed even in case that the display device 12 is a High Definition

Television (HDTV). Particularly, since the top page has a role to allow a user to overview the entirety, it is preferable to reconfigure the top page so as to fit in a predetermined image frame.

If the entire page is divided into a plurality of columns having the same breadth (800 pixels), which normally used when viewed by using a web browser, the number of pixels for four columns (800 times 4) is nearly 1920 times 1.5 pixels. Therefore, in the example shown in FIG. 7A, the number of columns to be reconfigured is defined as 4, and the breadth is defined as 1920×1.5 pixels. In case of defining the breadth dynamically, it is preferable that the page reconfiguration unit 110 reconfigures a page so that the page fits into an image frame having a predetermined aspect ratio, as described above.

The hierarchical data generating unit 120 defines the converted image as an image having the highest resolution, and reducing the image into a plurality of stages so as to generate hierarchical data. The image generated in accordance with the information on the page size corresponds to the image on the third layer 36 having the highest resolution in the example shown in FIG. 3. The number of stages, into which the image is reduced, may differ from page to page. The information on a transition between pages indicates information on transition between hierarchical data sets for respective page images. An explanation on the information on a transition between pages will be given later.

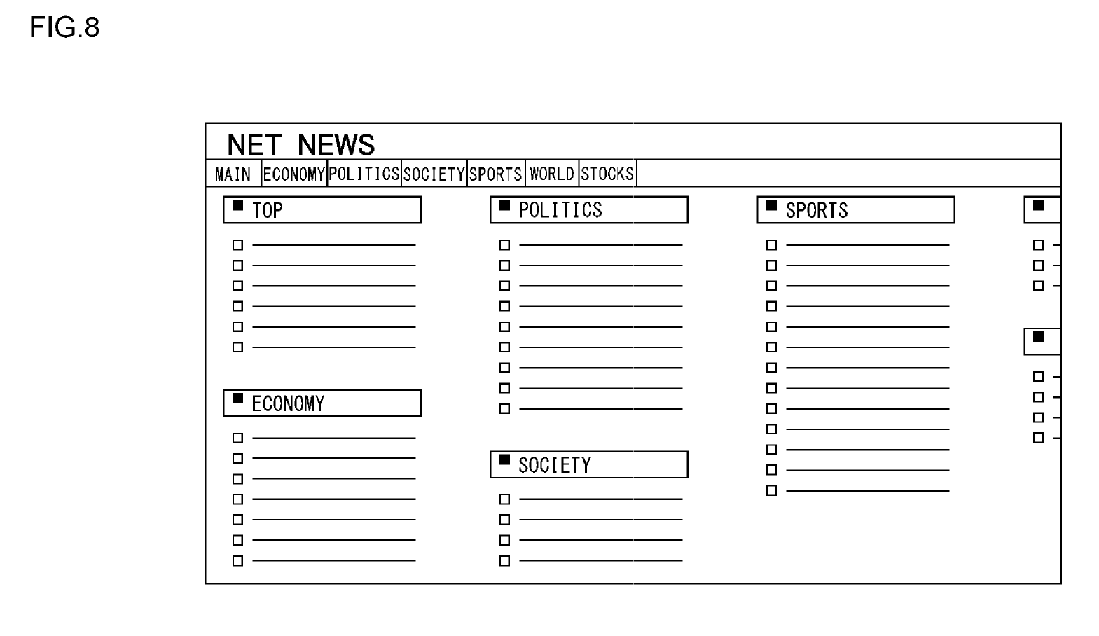

FIG. 8 shows an example of a top page image. The page reconfiguration unit 110 refers to the information on data to be used shown in FIG. 7A, extracts data required to generate a top page from the web data 122, and rearranges the extracted data into four columns. In this process, the page reconfiguration unit 110 defines the font size of news headlines as twice as large as the size specified by the web page, and generates top page data, accordingly. The hierarchical data generating unit 120 converts the top page data into an image so as to generate a top page image. As shown in FIG. 8, the top page image is configured so as to allow a user to overview news headlines of respective categories. When a user browses a reconfigured news site, this top page image is displayed on the display device 12 initially. Since a user can view news headlines included in respective categories, the user can quickly search and find a news item of interest. This proves that top page shown in FIG. 8 has increased viewer-friendliness in comparison with the top page shown in FIG. 6.

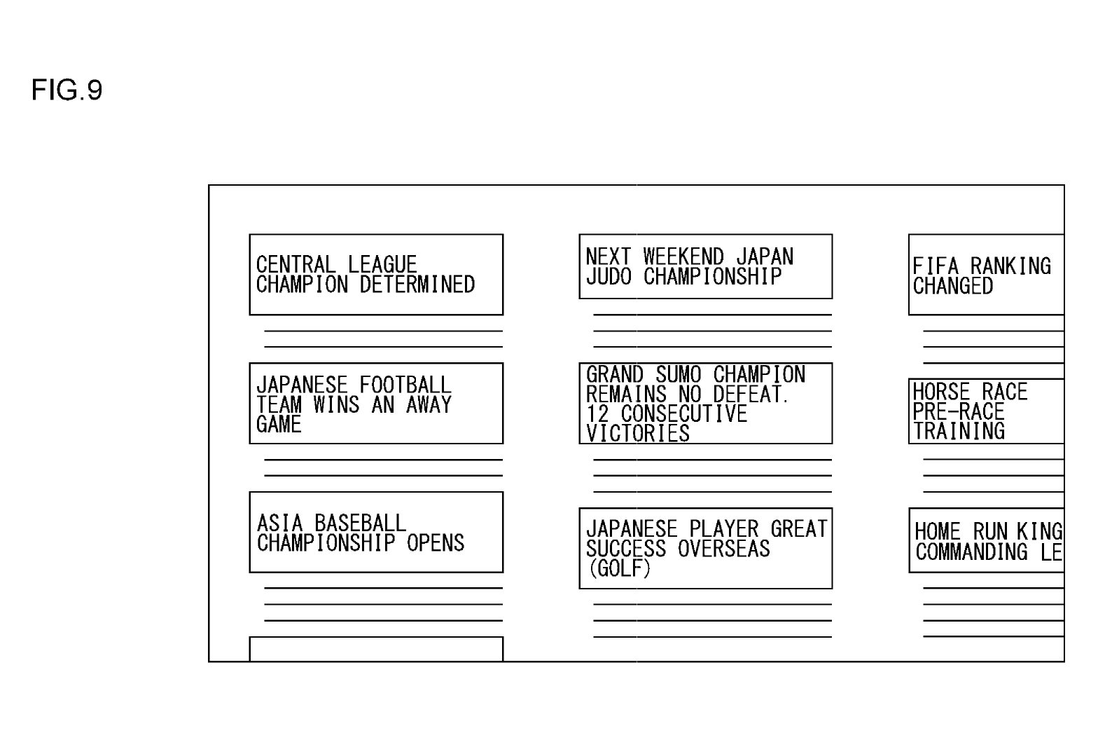

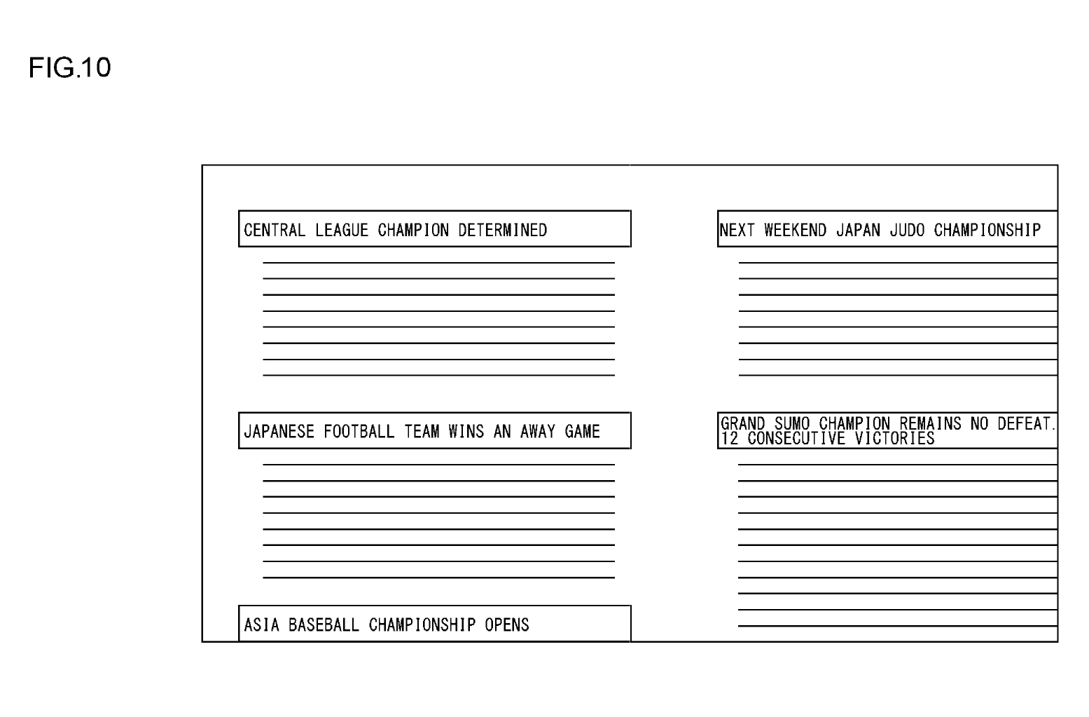

FIG. 9 shows an example of a summary page image. The summary page image indicates a list of news items belonging to the sports category. The page reconfiguration unit 110 refers to the information on data to be used shown in FIG. 7B, extracts data required to generate a summary page from the web data 122, and rearranges the extracted data into four columns. In this process, the page reconfiguration unit 110 defines the font size of news headlines as six times as large as the size specified by the web page, and generates summary page data, accordingly. The hierarchical data generating unit 120 converts the summary page data into an image so as to generate a summary page image. By increasing the enlargement factor of the news headlines, a user can view the headlines displayed with an emphasis, and thus can instantly specify a news item of which the user would like to view the content. That is, by enlarging the font size of news headlines to six times normal size, a user can overview a list of news items of a selected category. News text is displayed below the respective news headlines that are displayed with an emphasis.

FIG. 10 shows an example of a detail page image. As will be described later, in the information processing device 10 that uses hierarchical data, a summary page is switched to a detail page seamlessly by increasing the size of the summary page image being displayed. The page reconfiguration unit 110 refers to the information on data to be used shown in FIG. 7C, extracts data required to generate a detail page from the web data 122, and rearranges the extracted data into four columns. In this process, the page reconfiguration unit 110 defines the font size of news headlines as twice as large as the size specified by the web page, and generates detail page data, accordingly. The hierarchical data generating unit 120 converts the detail page data into an image so as to generate a detail page image.

The summary page data and the detail page data may be configured in the same manner except for the font size of news headlines. For example, the page reconfiguration unit 110 may first generate detail page data, and may generate summary page data by increasing the font size of the news titles in the generated detail page data to six times, without changing the layout thereof. Since the news headlines in the summary page image is enlarged in comparison with the news headlines in the detail page image, news text is concealed under the news headlines in the summary page image. However, since the summary page is generated in order to show a list of news items, news text may be concealed by a news headline. On the other hand, in the detail page, news headlines are scaled down in comparison with that of the summary page so that the concealed news text is displayed. This allows a user to read news items.

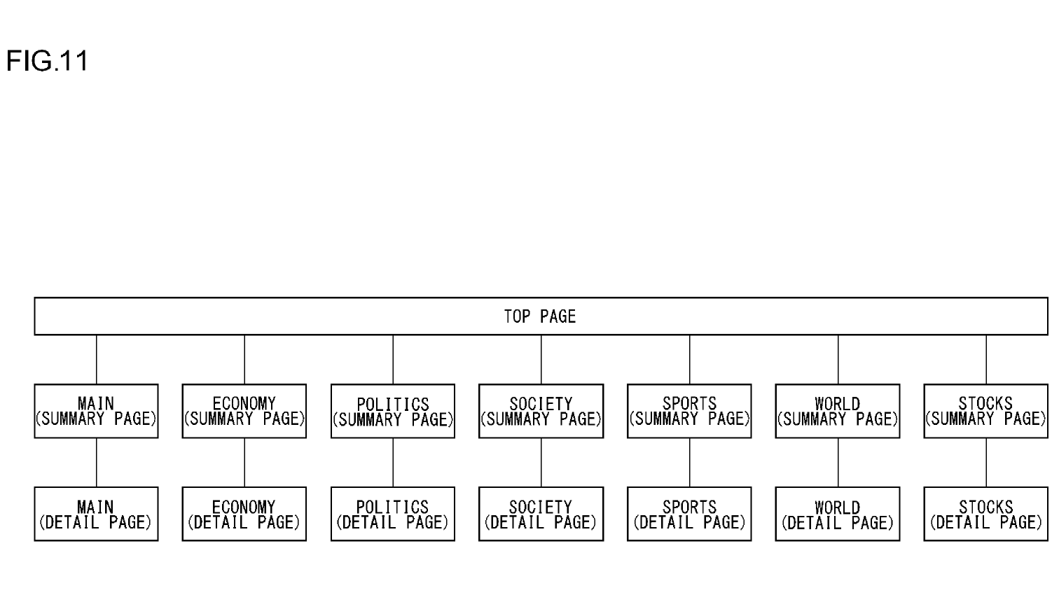

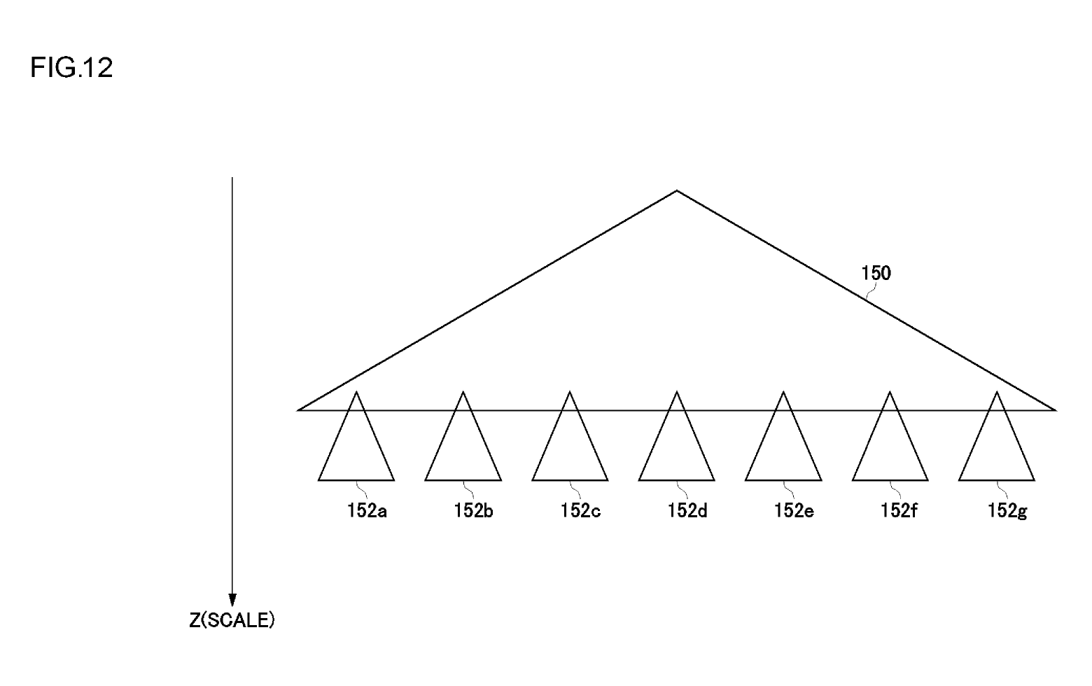

FIG. 11 shows the connection relationship among pages in three tiers (e.g., a top page, summary pages, and detail pages) in a hierarchical data structure. The information on the connection relationship is included in the configuration format data. The connection relationship shown in FIG. 11 indicates that the hierarchical data of the top page, the hierarchical data of the summary pages, and the hierarchical data of the detail pages are connected among each other. More specifically, the connection relationship means that links are defined between the hierarchical data of the top page and the hierarchical data of the summary pages, and between the hierarchical data of the summary pages and the hierarchical data of the detail pages, respectively. For example, upon increasing the size of the top page that is being displayed, the top page is switched to a summary page of sports, and upon increasing the size of the summary page of sports that is being displayed, the summary page of sports is switched to a detail page of sports so as to allow a user to view sports news items. The layouts for the summary page and for the detail page are substantially same. Therefore, upon switching from the summary page to the detail page, a seamless switching can be basically implemented with a mere changing of the relative size of news headlines.

FIG. 12 shows an example of connection among hierarchical data sets according to the exemplary embodiment. Connected to hierarchical data 150 of the top page are hierarchical data 152a of “main,” hierarchical data 152b of “economy,” hierarchical data 152c of “politics,” hierarchical data 152d of “society,” hierarchical data 152e of “sports,” hierarchical data 152f of “world,” and hierarchical data 152g of “stocks.” Each hierarchical data 152 comprises hierarchical data of a summary page, and hierarchical data of a detail page. As will be described later, if a user operates and scrolls the top page shown in FIG. 8 so that the “sports” category comes to the central area of the display device 12, and operates the top page so as to enlarge the top page, the transition from the top page to the summary page of the sports is made. That is, the summary page shown in FIG. 9 is displayed on the display device 12. Further, if a user operates the summary page shown in FIG. 9 so as to enlarge the summary page, the transition from the summary page to the detail page is made and the detail page shown in FIG. 10 is displayed on the display device 12.

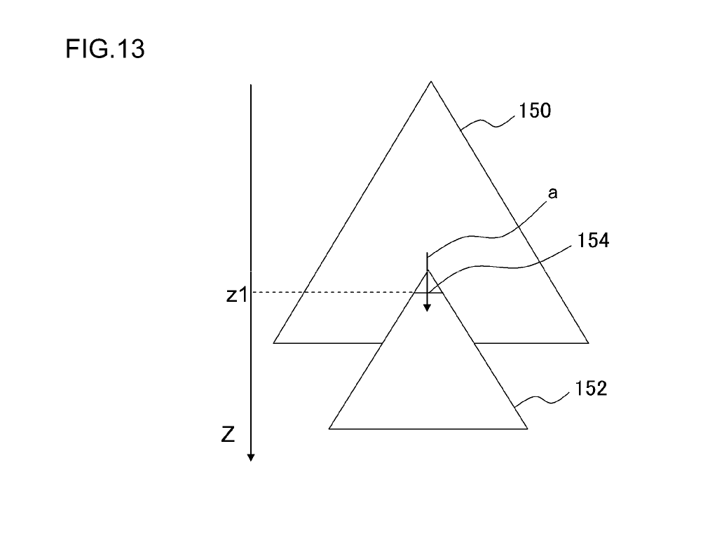

FIG. 13 schematically shows a relationship between sets of hierarchical data. In FIG. 13, two triangles indicate different sets of hierarchical data 150 and 152. Each of the hierarchical data 150 and 152 is actually configured as shown in FIG. 3 such that a plurality of sets of image data having different resolutions are discretely located along the z-axis direction of the figure. If a user requests to enlarge/reduce a display area via the input device 20, the display area, i.e., a viewpoint, moves in the z-axis direction of the figure. To move in the z-axis direction is identical to change the SCALE of the virtual camera image coordinates. Meanwhile, when a user requests to move the display area up, down, left, or right, the display area moves along the horizontal plane in the figure. To move along the horizontal plane is identical to change (X, Y) of the virtual camera image coordinates. In such a virtual space, the two sets of hierarchical data 150 and 152 establish a data structure where two sets of data overlap as shown in the figure.

If a user continuously makes a request for enlargement while an image of the hierarchical data 150 is displayed, the viewpoint moves as indicated by an arrow a, and enters into the area of the hierarchical data 152. In other words, the viewpoint moves between the hierarchical data sets. If the viewpoint enters into an area of different hierarchical data set, data used for generating an image to be displayed is switched from the hierarchical data 150 to the hierarchical data 152.

In order to establish image data comprising a plurality of sets of hierarchical data as shown in FIG. 13, the resolution (SCALE) and the position (X,Y) of an image when switching between the hierarchical data 150 and the hierarchical data 152 are defined in advance. This definition is shown as a line 154 in FIG. 13. In this way, the amount of overlap between the hierarchical data sets can be determined. In the example shown in FIG. 13, switching from the hierarchical data 150 to the hierarchical data 152 takes place at the resolution z1 defined by the z-axis and at the position indicated by the line 154. Such a connection between sets of hierarchical data is referred to as a link.

The z1 corresponds to the information SCALE of the information on a transition between pages included in the configuration format data shown in FIG. 7. The information on a transition between pages shown in FIG. 7A indicates that the virtual camera image coordinates when switching from a top page image to a summary page image is (x1, y1, scale1). The information on a transition between pages shown in FIG.

7B indicates that the virtual camera image coordinates when switching from a summary page image to a top page image is (x1, y1, scale1), and that the virtual camera image coordinates when switching from a detail page image to a summary page image is (x2, y2, scale2). The information on a transition between pages shown in FIG. 7C indicates that the virtual camera image coordinates when switching from a summary page image to a detail page image is (x2, y2, scale2). In the example shown in FIG. 13, a link from the hierarchical data 150 to the hierarchical data 152 is defined by z1. Referring to FIG. 12, the transition corresponds to a transition from the hierarchical data of the top page to the hierarchical data of the summary page. Therefore, the resolution zl corresponds to the scaling factor scalel. A transition from the hierarchical data of the summary page to the hierarchical data of the detail page takes place at the resolution z2, which is higher than the resolution z1. The resolution z2 corresponds to the scaling factor scale2.

The hierarchical data sets 150 and 152 are preferably configured with a common coordinate system. Thereby, the virtual camera image coordinates can be used among a plurality of sets of hierarchical data in a unified manner. In this case, the scaling factor SCALE is defined so as to increase gradually in accordance with the downward movement of the virtual camera image coordinates. In the above example, the scaling factor scalel is larger than the scaling factor scale2. The hierarchical data sets 150 and 152 may be configured with separate coordinate systems. In this case, coordinate transformations between the hierarchical data sets 150 and 152 can be sufficiently applied. As described above, by generating a plurality of sets of hierarchical data, a news top page with an excellent viewer-friendliness can be reconfigured. Further, news headlines can be displayed in a large size on a summary page, whereby a listing of news items for each category can be provided to a user. At the same time, by increasing the size of the listing of news items being displayed, individual news items can be provided to a user seamlessly. Accordingly, a news site with excellent viewer-friendliness can be reconfigured from web site data.

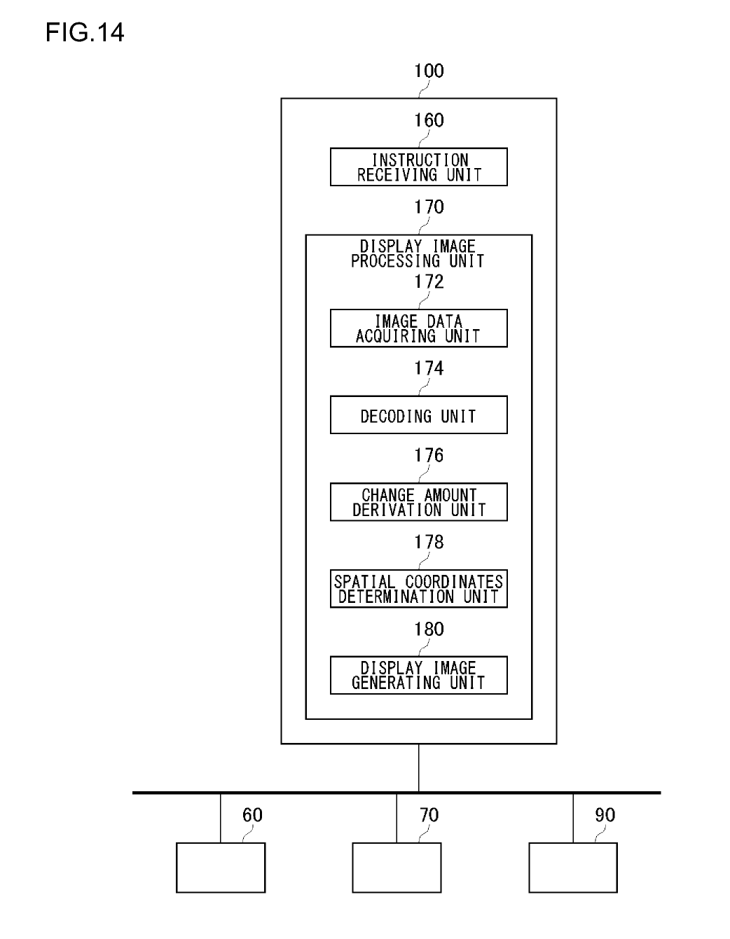

FIG. 14 shows the configuration of the control unit 100 that changes a displayed image. The control unit 100 comprises an instruction receiving unit 160 and a display image processing unit 170. The display image processing unit 170 is provided with an image data acquiring unit 172, a decoding unit 174, a change amount derivation unit 176, a spatial coordinate determination unit 178, and a display image generating unit 180. The display image processing unit 170 performs a process for changing a displayed image by using hierarchical data.

The elements depicted in FIG. 14 as functional blocks for performing various processes are implemented in hardware such as a Central Processing Unit (CPU), memory, or other LSI's, and in software such as a programs etc., loaded into the memory. As describe above, the control unit 100 includes one PPU and a plurality of SPUs. The PPU and the SPUs form one or more of the functional blocks alone or in combination. Therefore, it will be obvious to those skilled in the art that the functional blocks may be implemented in a variety of ways, by hardware only, software only, or a combination thereof. For example, the display image processing unit 170 may be configured by loading a program for changing an image.

If a user operates the input device 20 so as to give instruction to executes a process for changing an image, the instruction receiving unit 160 acknowledges the instruction, and the information processing device 10 activates the program for changing an image so as to start the process for changing an image by using hierarchical data. In this process, the hierarchical data is read out form the hard disk drive 50 and retained in the main memory 60.

As the user manipulates the analog stick 27 of the input device 20, the image change instruction signal is transmitted to the information processing device 10. The instruction receiving unit 160 acknowledges the change instruction signal for instructing the change of an image displayed on the display, the signal having been sent from the input device 20, and supplies the signal to the display image processing unit 170.

The image data acquiring unit 172 reads from the main memory 60 a tile image to be used to generate an image to be displayed, on the basis of the change instruction signal. The decoding unit 174 decodes the tile image and allows the buffer memory 70 to store the image. For example, it is preferable that the image data acquiring unit 172 predicts the scaling factor of the image requested by the change instruction signal to display, pre-fetches one or more tile images expected to be required in the future, and allows the buffer memory 70 to retain the pre-fetched images.

On the basis of the change instruction signal, the change amount derivation unit 176 derives a required amount of change of the displayed image. The amount of change of an displayed image comprises the amount of frame-by-frame movement in the vertical and horizontal directions and in the depth direction. The spatial coordinate determination unit 178 determines the texture coordinates of the current frame resulting from the movement based on the derived amount of change from the texture coordinates of the previous frame. The display image generating unit 180, on the basis of the texture coordinates, uses one or more tile images retained in the buffer memory 70 so as to generate an image to be displayed and supplies the generated image to the frame memory 90 of the display processing unit 44.

According to the exemplary embodiment, a top page image provides a user with a listing of news items included in a plurality of categories. The summary page image provides a user with a listing of news items included in one of the categories in a manner where news headlines are displayed with an emphasis. The detail page image provides a user with contents of individual news items. A user positions at the central area of the display device 12 a category, which the user would like to view from the listing of news items on the top page, and enlarges the top page being displayed in the status, by which the user can view the summary page of the desired category. A user positions at the central area of the display device 12 a news headline, which the user would like to view, included in the headlines displayed with an emphasis on the summary page, and enlarges the displayed image in that status, by which the user can view the news item being positioned at the central area.

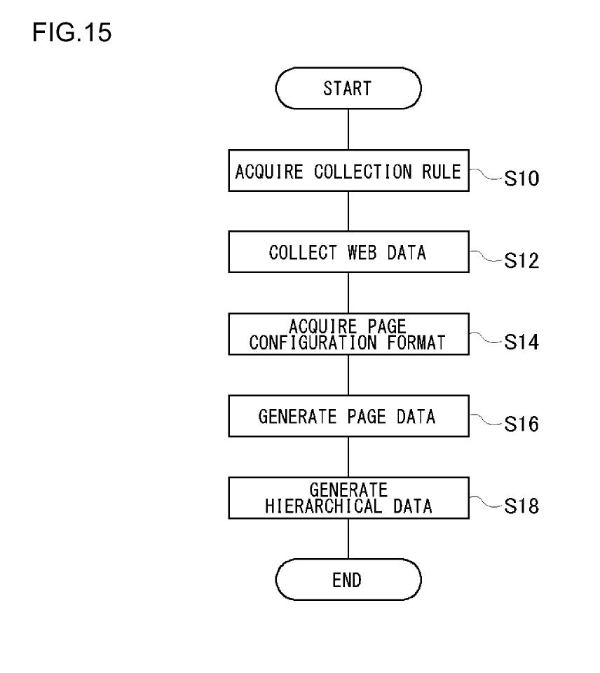

FIG. 15 shows a flowchart of a generation process of hierarchical data. First, the data collecting unit 102 acquires a collection rule of web data from the collection rule retaining unit 108 (S10). The data collecting unit 102 collects web data in accordance with the collection rule (S12). In this process, the analysis unit 106 analyses the web data acquired by the data acquiring unit 104 and the data acquiring unit 104 acquires web data required for generating a page.

The page reconfiguration unit 110 acquires from the format retaining unit 112 configuration format data of a page to be generated (S14). The page reconfiguration unit 110 generates page data wherein the acquired web data is arranged in accordance with the configuration format data (S16). The hierarchical data generating unit 120 generates a page image from the generated page data, and generates hierarchical data where page images of a plurality of resolutions are hierarchized by using the generated page image (S18). In the manner described above, hierarchical data that increases the viewer-friendliness of a website can be generated.

Given above is an explanation based on the exemplary embodiment. The exemplary embodiment described above is intended to be illustrative only and it will be obvious to those skilled in the art that various modifications to constituting elements and processes could be developed and that such modifications are also within the scope of the present invention.

According to the exemplary embodiment, data of web content is collected in accordance with the collection rule 1. However, web data that represents search results may be collected in accordance with the collection rule 2. For example, the search results at a conventional e-commerce site are displayed via a web browser with the images of commercial products and explanation information while being allocated in the vertical direction of an screen image. In this layout, since the number of commercial products that can be displayed is limited, it is not easy to compare commercial products among each other. Particularly, the layout is not preferable in case where a user would like to view images of a lot of commercial products in order to select a product to purchase.

Therefore, the information processing device 10 provides configuration format data that determines page configuration information of a top page where the explanation information of commercial products is omitted and only the images of commercial products are arranged in matrix. Although the size of each area for displaying an image of a commercial product may be fixed, the size of the area for displaying may be adjusted in accordance with the hit number of commercial products.

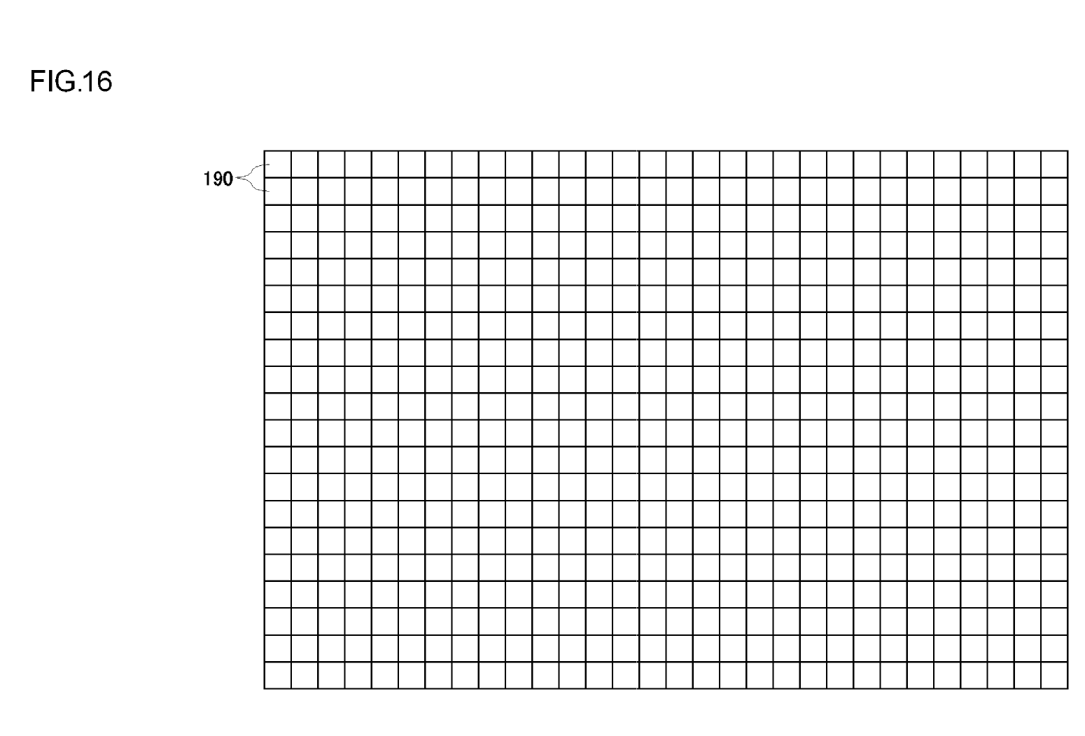

FIG. 16 shows an example of a top page image that displays a search result. As shown in FIG. 16, a plurality of display areas 190 are formed on the top page image, and an image of a commercial product is embedded in each display area 190. This allows a user to overview all search results, and the viewer-friendliness upon providing the search results can be increased. Upon increasing the size of the top image that is being displayed, the detail of a commercial product image that is disposed at the center of the display device 12 is displayed. As explained with the exemplary embodiment, the page reconfiguration unit 110 generates top page data for displaying as a list the content of search results as a whole, and page data for individual information (commercial products) to display individual information for respective commercial products. The hierarchical data generating unit 120 hierarchizes a top page image and commercial product page images and defines links between sets of hierarchical data. Generated in this manner is a structure of hierarchical data wherein, if a user enlarges a top page image that is being displayed, the top page image is switched to a commercial product page image.

According to the exemplary embodiment, the information processing device 10 performs a process for generating the hierarchical data. However, the image data generating server 18 may generate hierarchical data and may deliver the data to the information processing device 10 in case of a content, with which a lot of users desire to be provided. In some cases, such as the case of news site or the like taken up in the exemplary embodiment, hierarchical data may be generated preferably in the image data generating server 18 rather than in the information processing device 10. On the other hand, web information for personal use (e.g., web data acquired by a web search, etc.) is preferably collected by the information processing device 10 so as to generate hierarchical data.

### DESCRIPTION OF THE REFERENCE NUMERALS

1 . . . information processing system, 10 . . . information processing device, 16 . . . network, 17 . . . web server, 18 . . . image data generating server, 20 . . . input device, 100 . . . control unit, 102 . . . data collecting unit, 104 . . . data acquiring unit, 106 . . . analysis unit, 108 . . . collection rule retaining unit, 110 . . . page reconfiguration unit, 112 . . . format retaining unit, 120 . . . hierarchical data generating unit, 122 . . . web data, 124 . . . page reconfiguration data, 150, 152 . . . hierarchical data, 160 . . . instruction receiving unit, 170 . . . display image processing unit, 172 . . . image data acquiring unit, 174 . . . decoding unit, 176 . . . change amount derivation unit, 178 . . . spatial coordinate determination unit, and 180 . . . display image generating unit.

### INDUSTRIAL APPLICABILITY

The present invention can be applied to a technical field of information processing.

1. An information processing device connected with an information providing server comprising:
a data acquiring unit operative to acquire provided data from the information providing server;
a format retaining unit operative to retain configuration format data of a page;
a reconfiguration unit operative to generate page data wherein the provided data acquired by the data acquiring unit is arranged in accordance with the configuration format data retained in the format retaining unit; and
a hierarchical data generating unit operative to generate one or more page images from the generated page data, and to generate hierarchical data wherein page images of a plurality of resolutions are hierarchized by using the one or more page images generated.

2. An information processing device according to claim 1, further comprising a collection rule retaining unit operative to retain a collection rule of the provided data, wherein the data acquiring unit acquires the provided data in accordance with the collection rule.

3. An information processing device according to claim 1, wherein:
the information providing server is a web server which provides provided data in the format of a web page, and
the reconfiguration unit generates page data wherein the provided data is arranged in a manner different from that of the web page in accordance with the configuration format data.

4. An information processing device according to claim 3, wherein
the reconfiguration unit generates page data for a listing to display the contents of the website as a whole as a list and generates page data for individual information to display individual information in the website, and
the hierarchical data generating unit generates hierarchical data of a page image for a listing and hierarchical data of one or more page images for individual information and defines a link between the two sets of hierarchical data, so as to generate a structure of hierarchical data wherein, upon increasing the size of the page image for a listing that is being displayed, a transition is made to the page image for individual information.

5. A computer program embedded on a non-transitory computer-readable recording medium, comprising:
a module configured to acquire provided data from an information providing server;
a module configured to generate page data wherein the acquired provided data is arranged in accordance with page configuration format data retained in a format retaining unit;
a module configured to generate a page image from the generated page data; and
a module configured to generate hierarchical data wherein page images of a plurality of resolutions are hierarchized by using the generated page image.

6. (canceled)
